(19) United States
(12) Patent Application Publication
(10) Pub. No.: US 2007/0208616 A1
(43) Pub. Date: Sep. 6, 2007

(54) Method, system, and apparatus for advertising

(76) Inventor: Michael M. Choi, Provo, UT (US)

Correspondence Address: BRYAN K. HANKS, 9612 Blue Creek Lane, Austin, TX, 78758, US

(21) Appl. No.: 11/365,458

(22) Filed: Mar. 1, 2006

(51) Int. Cl. G06Q 30/00

(52) U.S. Cl. 705/14

(57) ABSTRACT

A method, system, and apparatus for enabling a display device to display advertisements is disclosed. The display device is enabled to simultaneously display a first advertisement and a representation of a geographical region. The geographical region is within a geographical super-region, and the geographical super-region is associated with a first entry in a database. The first advertisement is associated with the first entry in the database. The display device is also enabled to receive a selection of the geographical sub-region and display a second advertisement. The geographical sub-region is associated with a second entry in the database, and the second advertisement is associated with the second entry in the database.

### BACKGROUND OF THE DISCLOSURE

1. Field of the Disclosure

This disclosure relates to the field of electronic advertising, and more particularly relates to a method, system, and apparatus for associating advertisements with categories and geographical regions.

2. Description of the Related Art

The presently available paperback and electronic directories do not adequately meet the needs of advertisers or consumers. The following fictitious scenario illustrates how a consumer might search for a business using presently available directories.

5:00 p.m. Jacob is finishing up his work day at his new job. Today is his tenth anniversary, and he plans on taking his wife out to a nice Chinese restaurant to celebrate. However, Jacob and his family are new to Houston, and he hasn't heard of any good Chinese restaurants in the area. He needs to leave work in five minutes to pick up his wife on time, so he hurries to his bookshelf and grabs a paper-back directory for the League City area (Jacob and his family live in League City). He thumbs through the pages and finds the restaurants section, but the directory he grabbed does not sub-categorize the restaurants. The directory lists hundreds of restaurants in alphabetical order, but Jacob is unable to quickly identify any restaurants that look like they might have Chinese food.

5:05 p.m. Luckily, Jacob has another directory that covers the Houston metropolitan area. This time, the directory has sub-categories for restaurants. He finds a long list of Chinese restaurants. But Houston covers a huge geographical area, and he can't tell which restaurants are close to home. He calls a couple of restaurants to find out where they are located, but they are on the other side of town. Time is running out, so Jacob gives up on the paper-back directories.

5:09 p.m. Jacob turns his computer back on and logs in. He goes to his favorite on-line directory and searches for Chinese food in League City. The directory returns a long list of restaurants. Since he's already running late, he picks a Chinese restaurant with a familiar name and finally gets out the door at 5:13, knowing that he'll be late and wondering whether he picked a good restaurant.

Jacob's situation illustrates various deficiencies of present Internet-based and paper directories. For example, typical Internet-based and paper directories overload users with information. Hundreds of businesses may be listed on a single page. With so many businesses listed in such a small area, most businesses are unable to draw attention to their name. Paper directories often allow businesses to purchase advertising space, but the cost of advertising in these directories is often prohibitive, especially for small businesses. Advertising in paper directories may cost hundreds or thousands of dollars.

Internet-based directories remedy some of the deficiencies of paper directories. Some Internet-based directories allow businesses to publish links to their web-sites, purchase pop-up advertisements, or purchase other advertisement space. Internet-based directories may allow users to sort search results by distance from a point or may allow a user to get driving directions to a business. Some directories even provide a map that shows the locations of relevant businesses.

Despite these advantages of Internet-based directories, such directories present new challenges for users and still suffer from some of the problems associated with paper-back directories. For example, advertising with Internet-based directories is often cheaper than advertising with paper directories, but the prices may still be too high for many businesses. Furthermore, online directory interfaces often appear cluttered and overload users with too much information. Thus, it is difficult for advertisers to attract the attention of potential customers, and potential customers are often unable to make quick, informed decisions. Also, Internet-based directories may present pop-up advertisements that are not related to the types of businesses a consumer is searching for. As a final point, both Internet-based directories and paper-back directories are often difficult to navigate.

Part of the problem with directories is understandable because the interests of advertisers and consumers are somewhat in conflict. Consumers usually don't want to be overwhelmed with lists of hundreds of businesses while searching a directory. Many consumers would rather be well-informed about a few businesses and make their choice from among those businesses. Businesses, on the other hand, typically want to make sure that they are included in as many directory lists as possible to increase their exposure. Thus, some directories end up providing consumers with long lists of businesses without giving consumers enough information to make an educated decision as to which business is the best fit for their needs.

What is required, then, is a mechanism for displaying advertisements that allows businesses to capture the attention of potential customers. Such an approach should also allow users to quickly make effective decisions. Also, preferably, such a mechanism should be efficient for businesses and should allow consumers to easily navigate and assimilate information, thus reconciling the interests of consumers and businesses.

### SUMMARY

In one embodiment, a method for enabling a display device to display advertisements is disclosed. The method includes enabling the display device to simultaneously display a first advertisement and a representation of a geographical sub-region. The geographical sub-region is within a geographical super-region, and the geographical super-region is associated with a first entry in a database. The first advertisement is also associated with the first entry in the database. The method further includes receiving a selection of the geographical sub-region and enabling the display device to display a second advertisement. The geographical sub-region and the second advertisement are both associated with the second entry in the database.

In a similar embodiment, a method for enabling the display device to simultaneously display a first advertisement and a representation of a geographical super-region is disclosed. A geographical sub-region is within the geographical super-region. The geographical sub-region and a first advertisement are associated with a first entry in a database. The method also includes enabling the display device to display a second advertisement. The geographical super-region and a second advertisement are associated with a second entry in the database.

In another embodiment, a method for displaying advertisements is disclosed. The method includes simultaneously displaying a first advertisement and a map. The map represents a geographical sub-region, which is within a geographical super-region. The first advertisement is associated with the geographical super-region and the map.

In yet another embodiment, a system for enabling the displaying of advertisements is disclosed. The system includes a geography database. The geography database includes a first geographical entry associated with a geographical super-region and a second geographical entry associated with a geographical sub-region. The geographical sub-region is within the geographical super-region. The system also includes an advertisement database. The advertisement database includes a first advertisement associated with the first geographical entry, and a second advertisement associated with the second geographical entry. The system also includes a first module configured to enable simultaneous displaying of a representation of the geographical sub-region and the first advertisement.

Finally, in one embodiment a method for adding advertisements to a database is disclosed. A display device is enabled to display a representation of a first geographical region, and a selection of the first geographical region is received. The display device is also enabled to display a representation of a second geographical region, and the second geographical region is within the first geographical region. An advertisement is received, and a database entry is added to the database. The database entry associates the first geographical region with the advertisement.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description.

### BRIEF DESCRIPTION OF THE DRAWINGS

The present disclosure may be better understood, and numerous objects, features, and advantages made apparent to those skilled in the art by referencing the accompanying drawings.

FIG. 1 is a diagram illustrating a directory interface according to embodiments of the present disclosure.

FIG. 2 is a diagram illustrating a directory interface after receiving a selection of a region according to embodiments of the present disclosure.

FIG. 3 is a diagram illustrating a geography hierarchy according to embodiments of the present disclosure.

FIG. 4 is a diagram illustrating a category hierarchy according to embodiments of the present disclosure.

FIG. 5 is a diagram illustrating relationships between an advertisement matrix, a category hierarchy, and a geography hierarchy according to embodiments of the present disclosure.

FIG. 6 is a diagram illustrating relationships between an advertisement set, a category, and geographical regions.

FIG. 7 is a diagram illustrating relationships between an advertisement set, categories, and a geographical region.

FIG. 8 is a diagram illustrating a directory interface for uploading an advertisement according to embodiments of the present disclosure.

FIG. 9 is a diagram illustrating a directory interface for uploading an advertisement after the directory interface receives a selection of a geographical area and a category according to embodiments of the present disclosure.

FIG. 10 is a diagram illustrating an advertisement table according to embodiments of the present disclosure.

FIG. 11 is a diagram illustrating a keywords table according to embodiments of the present disclosure.

FIG. 12 is a diagram illustrating a statistics table according to embodiments of the present disclosure.

FIG. 13 is a diagram illustrating a directory interface for displaying an advertisement according to embodiments of the present disclosure.

FIG. 14 is a diagram illustrating a directory interface for displaying an advertisement after receiving a selection of a category according to embodiments of the present disclosure.

FIG. 15 is a diagram illustrating a directory interface for displaying an advertisement after receiving a selection of a sub-category according to embodiments of the present disclosure.

FIG. 16 is a diagram illustrating a directory interface for displaying an advertisement after receiving a selection of a geographical region according to embodiments of the present disclosure.

FIG. 17 is a diagram illustrating a directory interface for displaying an advertisement after receiving a selection of a second advertisement according to embodiments of the present disclosure.

FIG. 18 is a diagram illustrating a directory interface for displaying an advertisement after ascending a category hierarchy according to embodiments of the present disclosure.

FIG. 19 is a flow diagram illustrating an example of enabling displaying of advertisements according to embodiments of the present disclosure.

FIG. 20 is a flow diagram illustrating another example of enabling displaying of advertisements according to embodiments of the present disclosure.

FIG. 21 is a flow diagram illustrating an example of enabling uploading an advertisement according to embodiments of the present disclosure.

FIG. 22 depicts a block diagram of a database architecture according to embodiments of the present disclosure.

FIG. 23 depicts a block diagram of a computer system suitable for implementing embodiments of the present disclosure

FIG. 24 depicts a block diagram of a network architecture suitable for implementing embodiments of the present disclosure.

### DETAILED DESCRIPTION

The following is intended to provide a detailed description of various examples of the present disclosure and should not be taken to be limiting of the disclosure itself. Rather, any number of variations may fall within the scope of the present disclosure.

### Introduction

The present disclosure sets forth a method, system, and apparatus that addresses the disadvantages of prior systems by providing an efficient and effective approach to electronic advertising. The present disclosure allows consumers to quickly and effectively navigate a directory, but also gives advertisers the opportunity to capture the attention of potential consumers. Furthermore, the embodiments described in the present disclosure are typically cost-efficient for businesses and user-friendly for both businesses and their customers. An important part of providing these benefits is providing an effective mechanism, such as a directory interface, for allowing directory users to access the directory.

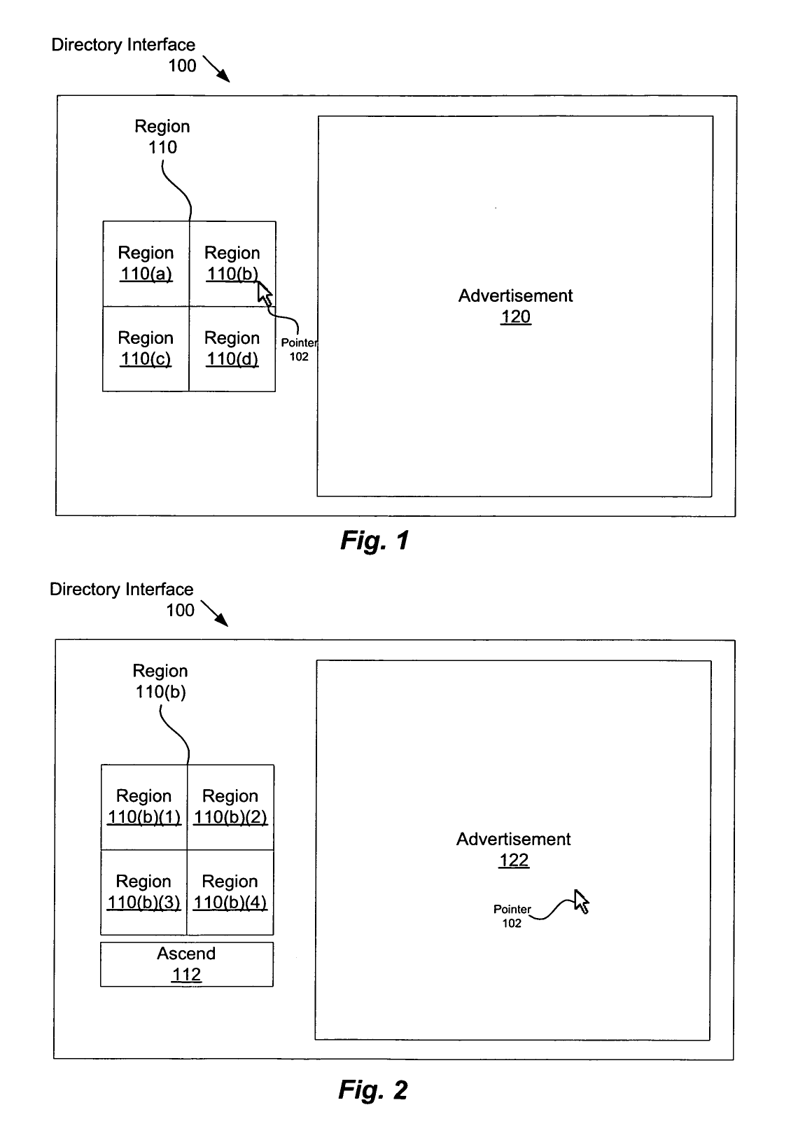

FIG. 1 illustrates an example of a directory interface 100. Directory interface 100 is typically displayed on a display device (e.g., screen, monitor, etc.) of a computer or other electronic device. Directory interface 100 shows a region 110 and an advertisement 120. Region 110 represents a geographical region. In the embodiment shown in FIG. 1, region 110 is referred to as the current geographical region. Advertisements displayed in display interface 100 are associated with the current geographical region. Thus, advertisement 120 is associated with region 110.

Region 110 is divided into multiple sub-regions. A region 110(a), a region 110(b), a region 110(c), and a region 110(d) are all within region 110. In other words, regions 110(a)-(d) represent geographical sub-regions that are within the geographical region represented by region 110. For example, if region 110 represents the United States, region 110(a) may represent the Northwestern United States, region 110(b) may represent the Northeastern United States, region 110(c) may represent the Southwestern United States, and region 110(d) may represent the Southeastern United States.

A user may select any of regions 110(a), 110(b), 110(c), and 110(d). FIG. 1 illustrates one example of how a user may select a region. The user places mouse pointer 102 over region 110(b) and clicks on region 110(b). After the user selects region 110(b), directory interface 100 refreshes and shows the sub-regions within region 110(b). Directory interface 100 also shows a new advertisement after the user selects region 10(b).

FIG. 2 illustrates directory interface 100 after directory interface 100 refreshes in response to the user's selection of region 110(b). The sub-regions within region 110(b) are now displayed in directory interface 100. These sub-regions include region 110(b)(1), region 110(b)(2), region 110(b)(3), and region 110(b)(4). The new advertisement displayed in directory interface 100 is an advertisement 122. Advertisement 122 is associated with the current region, which is now region 110(b). In one embodiment, when a user selects advertisement 122 with pointer 102, as shown in the FIG. 2, another advertisement is shown in place of advertisement 122. The advertisement that is shown in place of advertisement 122 is also associated with region 110(b).

Directory interface 100 also displays an ascend icon 112. If a user clicks on ascend icon 112, the user will ascend the geography hierarchy. In other words, selecting ascend icon 112 causes display interface 100 to refresh and show region 110 again. When the user ascends the geography hierarchy to region 110, an advertisement associated with region 110 will be displayed. The advertisement displayed may be advertisement 120, or may be another advertisement associated with region 110. Thus, each time a user selects a different geographical region, a new advertisement associated with the new geographical region is displayed.

A directory interface is one component of a system that allows a user to access advertisements. The following discussion illustrates an example of how databases, computer systems, and directory interfaces may interact according to some embodiments of the present disclosure. First, hierarchical databases are presented and explained. Second, the present disclosure demonstrates how businesses may add an advertisement to the directory. Third, the present disclosure shows how consumers may view advertisements in the directory. Fourth, marketing strategies are discussed. And finally, a, computer system, network, and database for implementing the features of the present disclosure are discussed.

Hierarchical Databases

According to some embodiments of the present disclosure, geographical regions are arranged in a hierarchy. Directory categories may also be arranged in a hierarchy. A user navigates a hierarchy by using a directory interface, as illustrated in the discussion of FIGS. 1 and 2. The associations between the entries in the hierarchies and the advertisement database determine which advertisements the directory interface displays to the user.

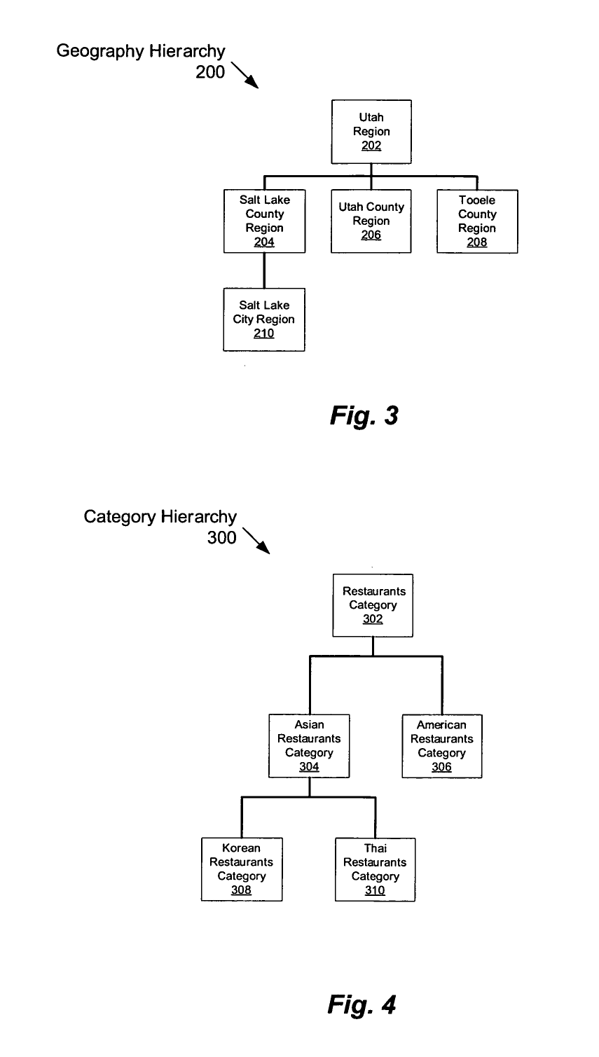

FIG. 3 illustrates a geography hierarchy 200. The first level of geography hierarchy 200 includes a Utah region 202. The second level of geography hierarchy 200 includes a Salt Lake county region 204, a Utah county region 206, and a Tooele county region 208, each of which is within Utah region 202. Finally, the third level of geography hierarchy includes a Salt Lake City region 210, which is within Salt Lake county region 204. In geography hierarchy 200, Utah region 202 may be considered a parent of Salt Lake county region 204, Utah county region 206, and Tooele county region 208. Thus, Salt Lake county region 204, Utah county region 206, and Tooele county region 208 may be considered children of Utah region 202. Similarly, Salt Lake county region 204 is a parent of Salt Lake City region 210, and Salt Lake City region 210 is a child of Salt Lake county region 204.

Geographical regions may be continents, countries, metropolitan areas, states, counties, cities, neighborhoods, zip code areas, etc. In some embodiments, the geographical regions strategically divide commercial areas. The geographical regions may also be divided and sub-divided along political boundaries, natural boundaries, or using any other boundaries.

FIG. 4 illustrates a category hierarchy 300. The first level of category hierarchy 300 includes a restaurants category 302. The second level of category hierarchy 300 includes an Asian restaurants category 304 and an American restaurants category 306. The third level of category hierarchy 300 includes a Korean restaurants category 308 and a Thai restaurants category 310. While restaurant categories are shown in category hierarchy 300, a category hierarchy may include any type of categories. Categories typically include various types of goods and services. In category hierarchy 300, restaurants category 302 may be considered a parent of Asian restaurants category 304 and American restaurants category 306. Thus, Asian restaurants category 304 and American restaurants category 306 may be considered children of restaurants category 302. Asian restaurants category 304 may be considered a parent of Korean restaurants category 308 and Thai restaurants category 310. Thus, Korean restaurants category 308 and Thai restaurants category 310 may be considered children of Asian restaurants category 304.

Geography hierarchy 200 and category hierarchy 300 display hierarchies with three levels and five entries, but it will be appreciated that such hierarchies may be implemented with any number of levels and entries. Furthermore, in some embodiments, the categories are not necessarily organized into hierarchies, but instead are set forth in lists, tables, or using other arrangement mechanisms.

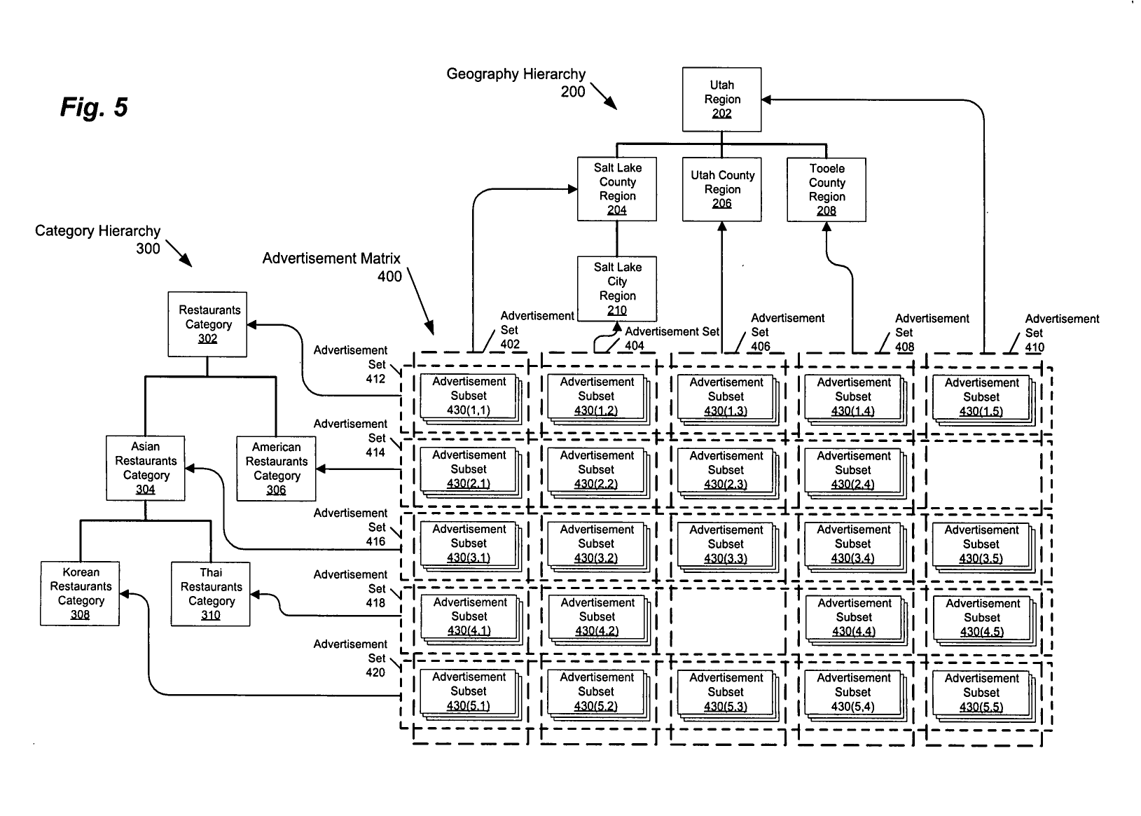

FIG. 5 is a diagram illustrating relationships between an advertisement matrix 400, category hierarchy 300, and geography hierarchy 200. Advertisement matrix 400 includes advertisement sets 402-420 and advertisement subsets 430(1,1)-430(5,5). Advertisement subsets 430(1,1)-430(5,5) are arranged as a matrix. The advertisements in advertisement matrix 400 may be included in an advertisement database. It is noted that advertisements may not necessarily be arranged in sets, subsets, and matrices. Advertisements may also be arranged in other configurations, such as a list or a table.

As shown in FIG. 5, advertisement set 402 is associated with Salt Lake county region 204, advertisement set 404 is associated with Salt Lake City region 210, advertisement set 406 is associated with Utah county region 206, advertisement set 408 is associated with Tooele county region 208, and advertisement set 410 is associated with Utah region 202. With respect to category hierarchy 300, advertisement set 412 is associated with restaurants category 302, advertisement set 414 is associated with American restaurants category 306, advertisement set 416 is associated with Asian restaurants category 304, advertisement set 418 is associated with Thai restaurants category 310, and advertisement set 420 is associated with Korean restaurants category 308.

Advertisements in advertisement matrix 400 are grouped in advertisement sets according to the relationships the advertisements have with categories and geographical regions. For example, if Spicy Thai, a Thai restaurant, wants to add a menu to the advertisement database, then Spicy Thai may associate the menu with Thai restaurant category 310. Because Thai restaurant category 310 is associated with advertisement set 418, the menu is included in advertisement set 418. If Spicy Thai is located in Salt Lake county, the restaurant may choose to associate the advertisement with Salt Lake county region 204, which is associated with advertisement set 402. Thus, the menu is also included in advertisement set 402. For an advertisement to be included in both advertisement sets 402 and 418, the advertisement would be included in advertisement subset 430(4,1). Thus, the menu from Spicy Thai is included in advertisement subset 430(4,1), which is the intersection of advertisement sets 402 and 418.

After the menu is added to advertisement matrix 400, a consumer may access the database to look for a Thai restaurant in Salt Lake county. The consumer first accesses a directory interface, and the directory interface may default to Utah region 202 and restaurants category 302. In this scenario, when the user first accesses the directory interface, the current region is Utah region 202 and the current category is restaurants category 302, and the directory interface will display an advertisement associated with Utah region 202 and restaurants category 302 (i.e., an advertisement from advertisement subset 430(1,5)). When the consumer selects Salt Lake county region 204, the directory interface refreshs to display an advertisement associated with Salt Lake county region 204 and restaurants category 302 (i.e., an advertisement from advertisement subset 430(1,1)). The consumer then selects Asian restaurants category, and is shown an advertisement from advertisement subset 430(3,1). Finally, the consumer selects Thai restaurants category 310. The display now shows an advertisement from advertisement subset 430(4,1). The display may show the menu from Spicy Thai first, but if it does not, the consumer may choose to see new advertisements until the menu from Spicy Thai is displayed.

The example of Spicy Thai restaurant demonstrates that advertisement subsets 430 may be accessed by navigating advertisement matrix 400 through category hierarchy 300 and geography hierarchy 200. It is noted that the advertisements are associated with a geographical region (e.g., a city) rather than being associated with a specific point (e.g. a physical address). This allows multiple advertisements to be associated with a single geographical region, thereby providing an efficient mechanism for uploading and accessing advertisements.

FIG. 5 also shows two locations in advertisement matrix 400 that do not include any advertisements. The intersection of advertisement sets 418 and 406 does not include any advertisements, and the intersection of advertisement sets 410 and 414 does not include any advertisements. If a consumer selects, for example, Thai restaurants category 310 and Utah county region 206, the directory interface may show an advertisement associated with Utah region 202 instead of showing an advertisement associated with Utah county region 206. Alternatively, the directory interface may display a default advertisement or a message indicating that there are no advertisements in the database for the selected category or region. The directory interface may also display a request to submit business names associated with the selected category and geographical region.

The number of advertisements associated with any given geographical region and category may change dynamically. Thus, advertisement subsets 430 may include any number of advertisements. In some embodiments, when the number of advertisements in a subset becomes too large, additional sub-categories may be added to category hierarchy 300 or additional sub-regions may be added to geography hierarchy 200.

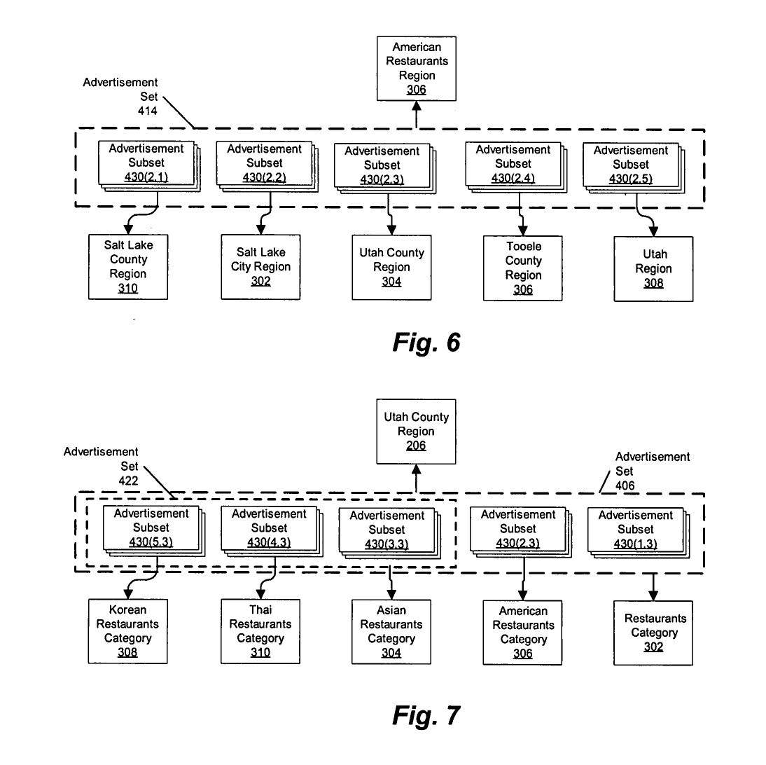

FIG. 6 is a diagram illustrating relationships between an advertisement set, a category, and geographical regions. FIG. 6 shows advertisement set 414, which is associated with American restaurants region 306. Advertisement subset 430(2,1) is associated with Salt Lake county region (310), advertisement subset 430(2,2) is associated with Salt Lake City region 302, advertisement subset 430(2,3) is associated with Utah county region 304, advertisement subset 430(2,4) is associated with Tooele county region 306, and advertisement subset 430(2,5) is associated with Utah region 308. FIG. 6 shows that each geographical region is associated with a different set of advertisements than every other geographical region. However, in some embodiments, a single advertisement or set of advertisements may be associated with multiple geographical regions or sub-regions.

For example, FIG. 7 shows that some categories are associated with multiple advertisement subsets. As previously discussed, an entry in a hierarchy may be considered as a parent or a child to another entry in a hierarchy. A hierarchy entry may inherent the associations of a child entry or a parent entry. FIG. 7 provides an example of such hierarchical inheritance.

FIG. 7 is a diagram illustrating relationships between an advertisement set, categories, and a geographical region. Utah county region 206 is associated with advertisement set 406, as also shown in FIG. 5. However, FIG. 7 shows some different category associations than FIG. 5. For example, Asian restaurants category 304 is associated with an advertisement set 422, which includes advertisement subset 430(5,3), advertisement subset 430(4,3), and advertisement subset 430(3,3). In FIG. 5, Asian restaurants category 304 is associated with advertisement subset 430(3,3) but is not associated with advertisement subset 430(4,3) and advertisement subset 430(5,3). In FIG. 7, Asian restaurants category 304 inherits the associations of its children, Thai restaurants category 310 and Korean restaurants category 308. Thai restaurants category 310 is associated with advertisement subset 430(4,3), and Korean restaurants category is associated with advertisement subset 430(5,3). Because Asian restaurants category 304 inherits the associations of its children categories, Asian restaurants category 304 is also associated with advertisement subset 430(5,3) and advertisement subset 430(4,3).

Restaurants category 302 also inherits the associations of its children. Restaurants category 302 inherits the associations of both American restaurants category 306 and Asian restaurants category 304. Furthermore, since Asian restaurants category 304 inherits the associations of its children, American restaurants category 306 also inherits the associations of Korean restaurants category 308 and Thai restaurants category 310. Thus, restaurants category 302 is associated with advertisement subset 430(5,3), advertisement subset 430(4,3), advertisement subset 430(3,3), and advertisement subset 430(2,3). Restaurants category 302 is also associated with advertisement subset 430(1,3). Accordingly, restaurants category 302 is associated with each advertisement subset within advertisement set 406 (i.e., restaurants category 302 is associated with advertisement set 406).

The example illustrated in FIG. 7 shows how category entries in a hierarchy may inherit the associations of their children. While entries in a category hierarchy typically inherent the associations of their children, entries in a category hierarchy may inherit the associations of their parents or of both their parents and children. Entries in a geography hierarchy typically do not inherit the associations of their parents or their children. But in some embodiments, entries in a geography hierarchy may inherit such associations.

Uploading Advertisements

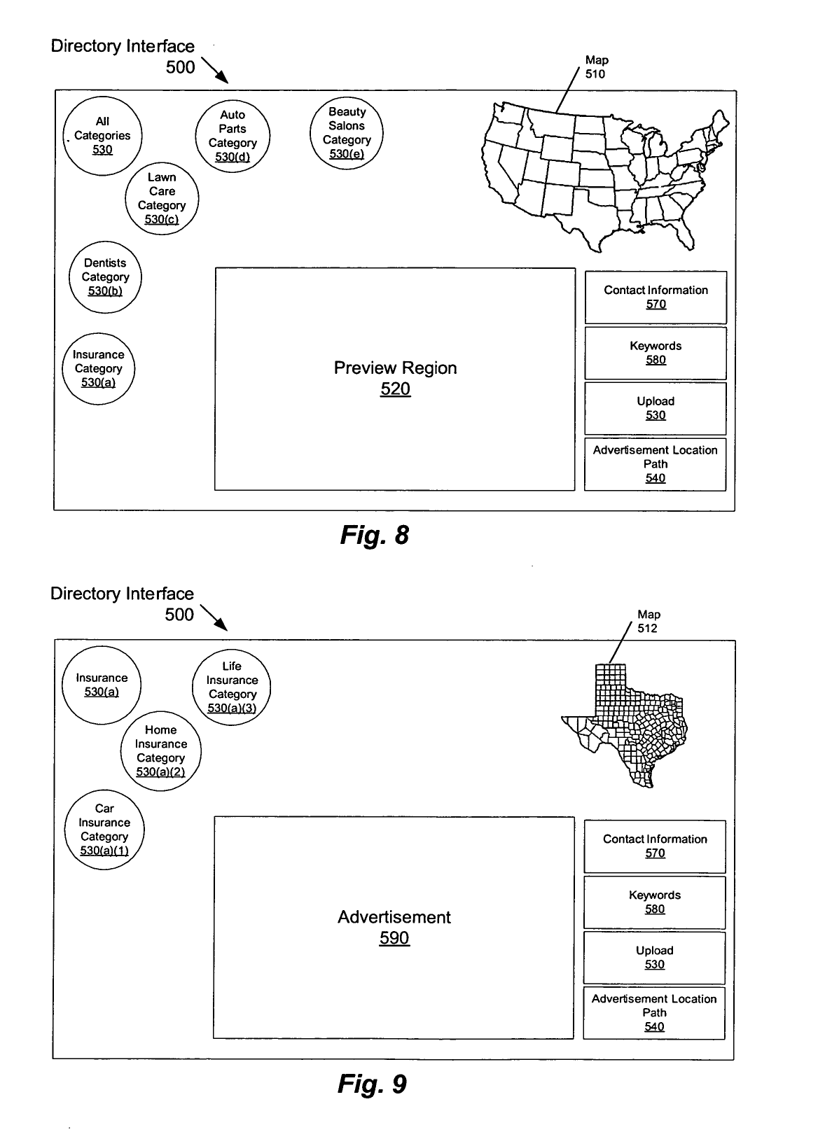

The previous figures and discussion show how geographical regions, categories, and advertisements are associated with one another. Now the discussion turns to FIGS. 8-11 to address adding advertisements to an advertisement database. The advertisements may be added by a business representative, by a directory administrator, or by any other individual with the ability to access the advertisement database. Advertisements may be added automatically through a directory interface, or may be manually entered into a database. Other mechanisms for adding entries to an advertisement database, such a linking the advertisement database to another database, will also work with the embodiments discussed in the present disclosure.

FIGS. 8 and 9 illustrate a display interface for adding an advertisement to a directory. Directory interface 500 displays a preview region 520, an all categories icon 530, an insurance category 530(a), a dentists category 530(b), a lawn care category 530(c), an auto parts category 530(d), and a beauty salons category 530(e). Display interface 500 also displays an upload icon 530, an advertisement location path box 540, a contact information box 570, a keywords box 580, and a map 510. Directory interface 500, as shown in FIG. 8, may be the first screen presented to a user seeking to upload an advertisement. A user may access directory interface 500 by logging in to a directory provider's website, starting a directory interface program, or using any other mechanism capable of presenting an interface to a user.

A user may upload an advertisement by entering a location of the advertisement in advertisement location path box 540 and selecting upload icon 530. The user may enter a URL, a path to a local drive, or a path to a network drive in advertisement location path box 550. Alternatively, upload icon 530 may allow a user to browse the user's computer or network to find an advertisement to upload. The advertisement may be in any computer readable format (e.g., .bmp, gif, tiff, jpg, .png, .pcx, etc.). When the advertisement is uploaded, it is associated with the current category and the current geographical region. In FIG. 8, the current category is all categories 530, and the current region is the United States (Map 510).

A user may wish to associate an advertisement with the “all categories” category and the United States. For example, a web hosting business, Web Hosts, desires to add an advertisement to the advertisement database and associate the advertisement with the “all categories” category and the United States. A Web Hosts employee accesses directory interface 500 and enters a path to an advertisement in advertisement location path box 540. The Web Hosts employee also enters “Web Hosting” in keywords box 580 and “1-800-123-4567” in contact information box 570. The advertisement is added to the advertisement database when the employee selects upload icon 530. In some embodiments, the advertisement database adds a new entry to an advertisement table each time a new advertisement is added.

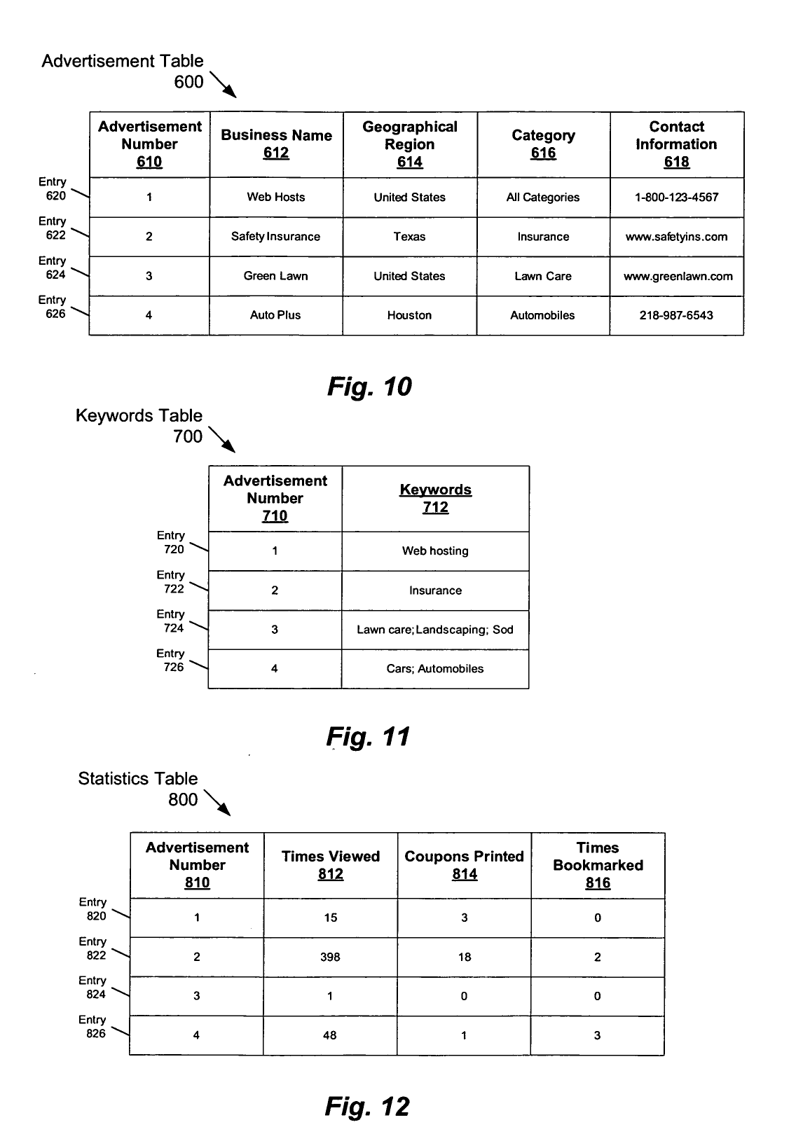

FIG. 10 illustrates a diagram of an advertisement table 600. Each entry in advertisement table 600 includes an advertisement number field 610, a business name field 612, a geographical region field 614, a category field 616, and a contact information field 618. An advertisement table may also include different fields than are shown in advertisement table 600. When the employee for Web Hosts uploads the advertisement, entry 620 is added to advertisement table 600. The advertisement is also assigned an advertisement number, which is the number “1” for entry 620.

Advertisement table 600 is an example of a mechanism that tracks the associations between advertisements, geographical regions, and categories. Another example of such a mechanism is advertisement matrix 400, which is shown in FIG. 5. Table 600 may be used in conjunction with an advertisement matrix, or either mechanism may be used independently of the other mechanism.

FIG. 11 is a diagram of a keywords table 700. Each entry in keywords table 700 includes an advertisement number field 710 and a keywords field 712. An entry may be added to keywords table 700 when a user adds an advertisement to the advertisement database. For example, when the employee for Web Hosts adds an advertisement to the database, entry 720 is added to keywords table 700.

Referring back to FIGS. 8 and 9, a user may select a new category and a new geographical region before uploading an advertisement. For example, a Texas insurance company, Safety Insurance, desires to upload an advertisement and associate the advertisement with insurance category 530(a) and with the state of Texas. Before uploading the advertisement, an agent for Safety Insurance selects insurance category 530(a) and then selects map 512. As shown in FIG. 9, display interface 500 now shows the sub-categories of insurance category 530(a) and the sub-regions of map 512. The sub-categories of insurance category 530(a) include a car insurance category 530(a)(1), a home insurance category 530(a)(2), and a life insurance category 530(a)(3).

After selecting insurance category 530(a) and Texas map 512, the Safety Insurance agent enters “www.safetyinsurance.com” in contact information box 570 and “insurance” in keywords box 580. The agent then uploads an advertisement. When the advertisement is uploaded, entry 622 is added to advertisement table 600, and entry 722 is added to keywords table 700. As shown in entry 622, the advertisement is associated with the geographical region of Texas and the insurance category. Advertisement table 600 also shows entries 624 and 626, which are added to advertisement table 600 in a manner similar to the way entries 620 and 622 were added. Similarly, keywords table 700 also includes entries 724 and 726.

Advertisers may want to be the first or one of the first advertisements that is displayed when a certain category and geographical region are selected. In some embodiments, advertisers may pay a premium to have their advertisement show up first or to increase the probability that their advertisement will be one of the first advertisements displayed. Alternatively, the order that advertisements are displayed may be selected randomly, or may be selected based on when the advertisement was added to the database.

Advertisers may also desire to upload coupons. Coupons may be uploaded in the same manner that advertisements are uploaded. Coupons are typically associated with an advertisement, but coupons may also be independently associated with a category and a geographical region.

The advertising mechanism of the present disclosure provides numerous advantages for advertisers. For example, a business can easily target certain geographical areas and categories. Furthermore, business may show one advertisement at a national level, a different advertisement at a regional level, and a more specific advertisement at a local level. The business is also able to capture the attention of potential customers when their advertisement is the only advertisement shown in the display interface.

FIG. 12 is a diagram of a statistics table 800. Statistics table 800 provides businesses or other users with information that may help determine the effectiveness of an advertisement. Statistics table 800 includes an advertisement number field 810, a times viewed field 812, a coupons printed field 814, and a times bookmarked field 816. Times viewed field 812 displays the number of times that an advertisement is viewed, coupons printed field 814 displays the number of times that a coupon associated with the advertisement is printed, and times bookmarked field 816 displays the number of times the advertisement has been bookmarked. Statistics table 800 includes an entry 820, an entry 822, an entry 824, and an entry 826. A statistics table may also include more fields than are illustrated in statistics table 800.

According to some embodiments, a business must have at least one building located within a geographical area to associate an advertisement with the geographical area. In some embodiments, online businesses are only allowed to place their advertisements at the highest level in the geography hierarchy. In other embodiments, all businesses may place their advertisements at any level in the geography hierarchy. The directory interface may also allow businesses to associate an advertisement with multiple geographical regions or multiple categories.

Viewing Advertisements

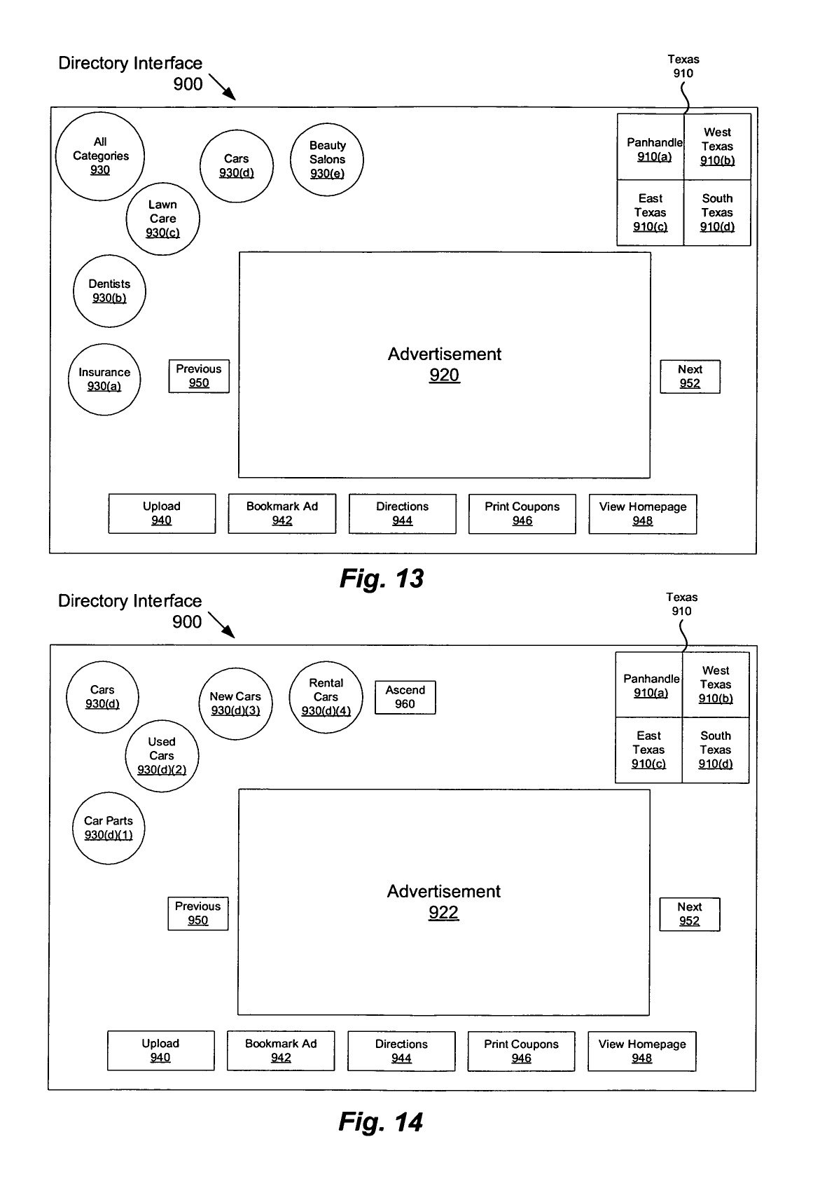

After an advertisement is uploaded to the advertisement database, consumers may use a directory interface to view the advertisements. FIGS. 13-18 illustrate an example of a directory interface that allows consumers to view advertisements in the advertisement database. In some embodiments, the database is stored on a server and the display is shown on a client machine (e.g., an Internet-based system). In other embodiments, the database may be stored on a computer with a directory interface. Directory interfaces may be displayed on personal computers, laptops, cellular telephones, personal handheld devices, or any other electronic devices capable of communicating data to an interface. The database may be included in a compact disc or any other type of computer readable media (e.g., flash memory, DVD, etc.).

Various types of advertisements may be added to the advertisement database. The advertisements may be a few lines of plain text or complex animations. The advertisements may also include any type of business information, from restaurant menus to department store sales. In some embodiments, the directory interface only displays one advertisement at a time, which allows businesses to capture a users attention and allows users to make more informed decisions about the businesses. In other embodiments, the directory interface may display multiple advertisements at the same time.

If the directory is implemented as an Internet-based directory, a user may access the directory using a web browser. The directory home page may display a default category and a default geographical area. The home page may also display an advertisement associated with the default category and the default geographical area. In some embodiments, a physical location of the client computer is determined (e.g., by using the client computer's IP address) and the display interface sets the current geographical region based on the physical location of the client computer. For example, the directory homepage may display a Texas region to a user located in Austin, Texas. A user may also be able to customize the directory interface by choosing a default category and a default geographical area. Alternatively, the default category and geographical area may be chosen by monitoring a user's database activity.

FIG. 13 is a diagram illustrating a directory interface 900. Directory interface 900 displays an all categories icon 930, an insurance category 930(a), a dentists category 930(b), a lawn care category 930(c), a cars category 930(d), and a beauty salons category 930(e). Directory interface 900 also displays a Texas region 910, and an advertisement 920. In FIG. 13, the current category is the “all categories” category, and the current geographical region is Texas. Thus, advertisement 920 is associated with the “all categories” category and Texas.

FIG. 13 also shows a previous icon 950 and a next icon 952. These icons allow a user to view additional advertisements associated with the current category and the current geographical region. Directory interface 900 also displays an upload icon 940, a bookmark ad icon 942, a directions icon 944, a print coupons icon 946, and a view homepage icon 948. When a user selects upload icon 940, directory interface 900 may display an interface that allows a user to upload an advertisement. Bookmark ad icon 942 allows a user to bookmark an advertisement for future reference. Directions icon 944 provides a user with driving directions or a map of the business that sponsors the current advertisement. Print coupons icon 946 allows a user to print coupons related to the current advertisement, and view homepage icon 948 takes a user to the homepage of the business that sponsors the current advertisement.

According to some embodiments, directory interface 900 may also be configured to show consumers how far they are from the business that sponsors the current advertisement. For example, a consumer provides an address and the directory interface displays how many miles or minutes the consumer is from the business. In some embodiments, a consumer's address is saved, and the directory interface automatically displays how far the consumer is from the businesses.

Directory interface 900 also shows sub-regions of Texas region 910. The sub-regions of Texas region 910 include a panhandle region 910(a), a West Texas region 910(b), an East Texas region 910(c), and a South Texas region 910(d). The regions and sub-regions shown in the interface are representations of geographical regions, and may be maps or textual descriptions of the geographical regions that they represent. The textual description may be a zip code, a name of a city, a name of a state, etc. The geographical regions may be any demarcated area of the earth. Geographical region 910 may be considered a geographical super-region because geographical region 910 is subdivided into sub-regions. Geographical region 910 may also be a sub-region of another super-region. Geographical sub-regions are within geographical super-regions, and may or may not share one or more boundaries with the super-region.

FIG. 14 is a diagram illustrating a directory interface for displaying an advertisement after receiving a selection of a category. As previously mentioned, directory interface 900 may appear as shown in FIG. 13 when a user first accesses directory interface 900. If the user selects cars category 930(d), directory interface 900 refreshes and appears as shown in FIG. 14. Directory interface 900 now also displays an ascend button 960, which allows a user to return to a higher level in the category hierarchy. Alternatively, directory interface 900 may allow a user ascend the category hierarchy by selecting category 930(d), which is now shown in the upper-left-hand corner of directory interface 900.

After receiving the selection of cars category 930(d), directory interface 900 shows an advertisement 922. Directory interface 900 also show the sub-categories of car category 930(d), which include a car parts category 930(d)(1), a used cars category 930(d)(2), a new cars category 930(d)(3), and a rental cars category 930(d)(4). In FIG. 14, the current category is cars, and the current geographical region is Texas. Thus, advertisement 922 is associated with cars category 930(d) and with Texas region 910.

It is noted that a directory interface does not necessarily display the current geographical region and the current category. For example, a directory interface may display only the sub-regions of the current geographical region and the sub-categories of the current category.

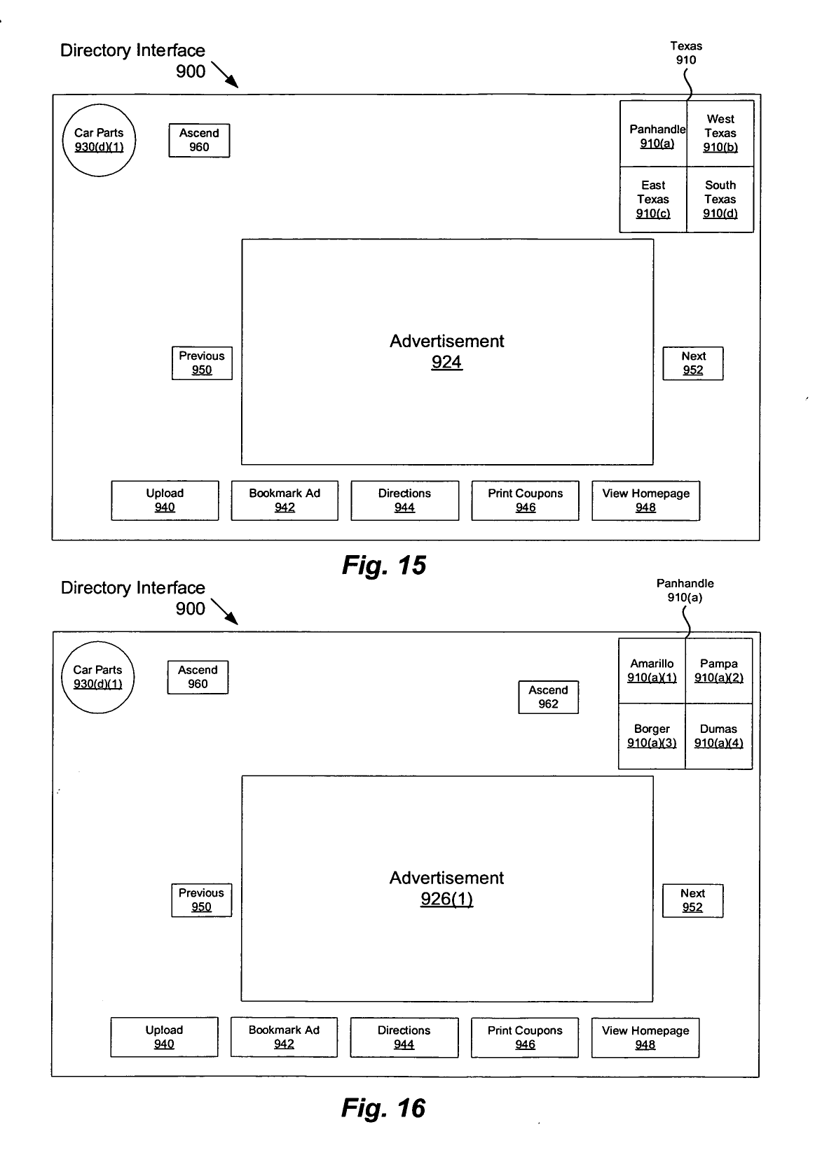

After selecting cars category 930(d), a user may select car parts category 930(d)(1). FIG. 15 illustrates how directory interface 900 appears after car parts category 930(d)(1) is selected. Car parts category 930(d)(1) does not have any sub-categories; thus, directory interface 900 only displays car parts category 930(d)(1). FIG. 15 also shows an advertisement 924, which is associated with car parts category 930(d)(1) and Texas region 910.

FIG. 16 illustrates directory interface 900 after the user selects panhandle region 910(a). Directory interface 900 now shows the sub-regions of panhandle region 910(a), an advertisement 926(1), and an ascend icon 962. The sub-regions of panhandle region 910(a) include an Amarillo region 910(a)(1), a Pampa region 910(a)(2), a Borger region 910(a)(3), and a Dumas region 910(a)(4). Ascend icon 962 allows a user to ascend the geographical hierarchy and return to the previous geographical region. Advertisement 926(1) is associated with car parts category 930(d)(1) and panhandle region 910(a).

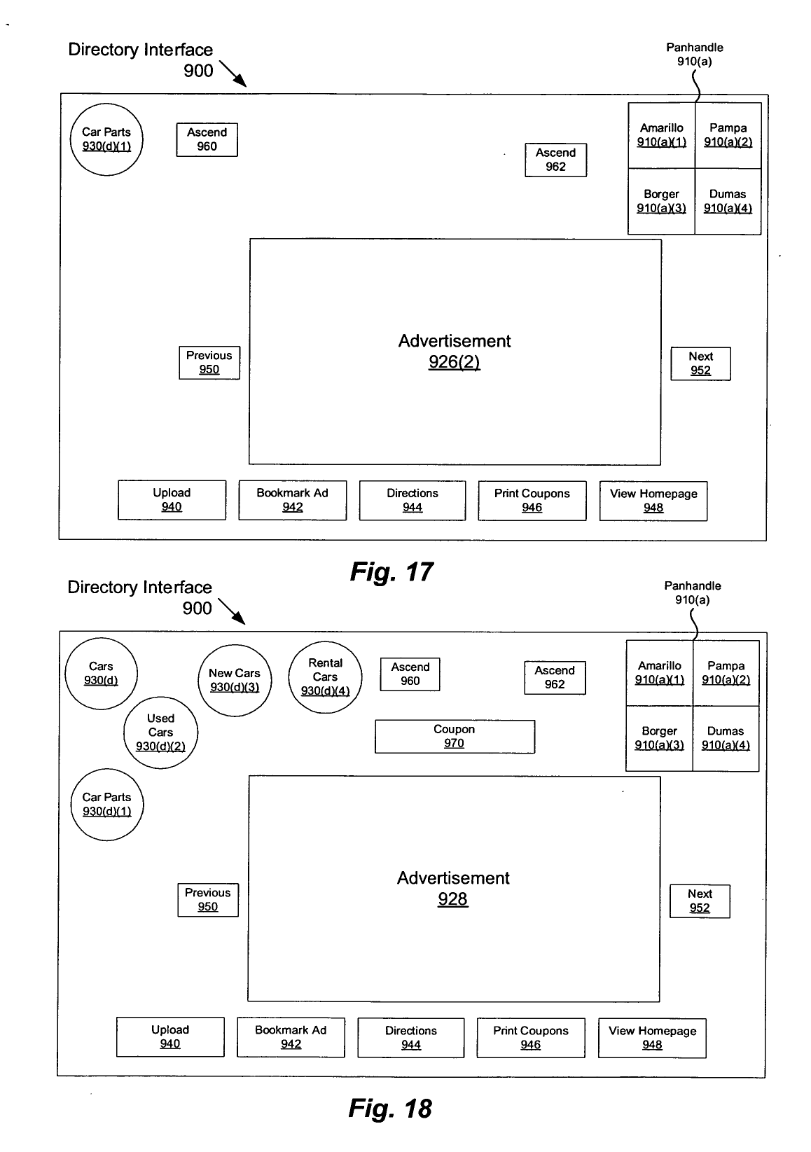

FIG. 17 is a diagram illustrating directory interface 900 after a user selects next icon 952. When a user selects next icon 952, directory interface 900 displays an additional advertisement associated with the current category and the current geographical region. As shown in FIG. 17, directory interface 900 now displays advertisement 926(2). If the user wishes to see advertisement 926(1) again, the user may click on previous icon 950. Next icon 952 and previous icon 950 allow a user to scroll through all the advertisements associated with the current category and geographical region.

In order to display the appropriate advertisements, an advertisement table may be searched to find the advertisements that are associated with the current geographical region and the current category. Also, an advertisement set associated with the current geographical region and the current category may be accessed using an advertisement matrix. Alternatively, advertisements may be tagged with data associating the advertisements with geographical regions and categories.

Instead of using previous and next icons, the directly interface may allow a user to view the next advertisement by clicking on the current advertisement. Alternatively, the display may present each advertisement for a fixed amount of time (e.g. 10 seconds), or a variable amount of time (e.g., advertisers may pay more to have their advertisements shown longer).

FIG. 18 is a diagram illustrating a directory interface for displaying an advertisement after ascending a category hierarchy according to embodiments of the present disclosure. If a user selects ascend icon 960, directory interface 900 will return to the parent category of the current category. For example, after selecting ascend icon 960 in FIG. 17, directory interface 900 displays cars category 930(d), as shown in FIG. 18. The current category is now cars category 930(d), and the current geographical region is still panhandle region 910(a). Directory interface 900 displays an advertisement 928, which is associated with panhandle region 910(a) and cars category 930(d). Directory interface 900 also displays a coupon 970, which is associated with advertisement 928. In some embodiments a user may select the option to only see advertisements that are associated with coupons.

The directory interfaces presented in the present disclosure have been shown to display one advertisement. In some embodiments, a directory interface may display multiple advertisements at the same time. A directory interface may also simultaneously display driving directions and advertisements.

The mechanisms for displaying advertisements presented in the present disclosure provide numerous advantages for consumers. Consumers are able to quickly locate businesses that will meet their needs. In some embodiments, consumers may access the directory by clicking on category icons and maps. This means that the consumers do not have to use a keyboard to navigate the directory. Furthermore, consumers are not overloaded with information when the directory interface is not cluttered with multiple advertisements and business listings.

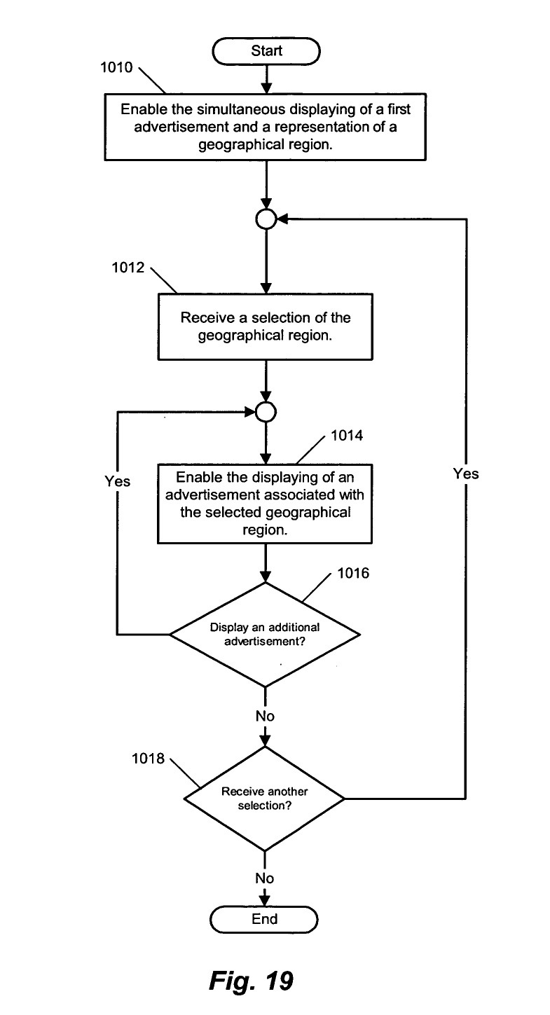

FIG. 19 is a flow diagram illustrating an example of enabling displaying of advertisements. First, an enabling mechanism enables the simultaneous displaying of a first advertisement and a representation of a geographical region (step 1010). Then, a receiving mechanism receives a selection of the geographical region (step 1012). Next, the enabling mechanism enables the displaying of an advertisement associated with the selected geographical region (step 1014). A determining mechanism determines whether to display an additional advertisement (step 1016). If an additional advertisement is to be displayed, the enabling mechanism enables the displaying of an additional advertisement (step 1014). If an additional advertisement is not to be displayed, the determining mechanism determines whether another selection of a geographical region has been received (step 1018). If another selection of a geographical region has been received, steps 1012 through 1016 are repeated.

The receiving mechanism, the enabling mechanism, and the determining mechanism may be part of a single computer or may be parts of different computers. For example, the receiving mechanism, the enabling mechanism, and the determining mechanism may be in a client computer or a server. Alternatively, any one of the mechanisms may be included in a client computer with the remaining mechanisms being included in a server. Furthermore, the enabling mechanism may also be a signal that is sent between computers.

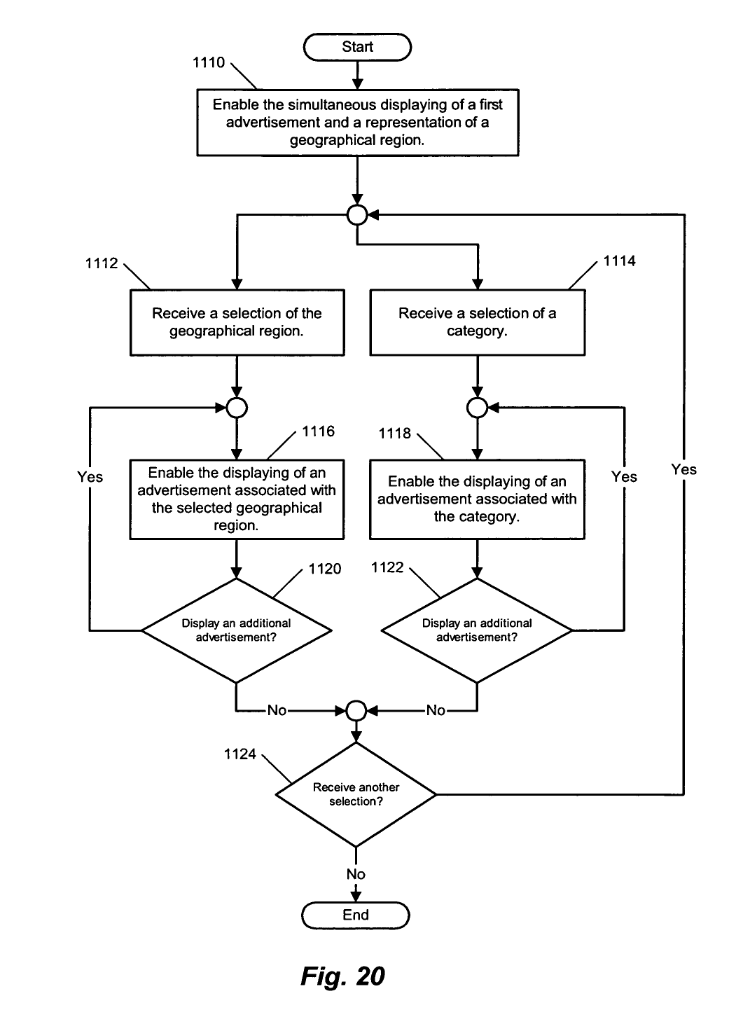

FIG. 20 is a flow diagram illustrating an example of enabling displaying of advertisements. An enabling mechanism enables the simultaneous displaying of a first advertisement and a representation of a geographical region (step 1110). Then, a receiving mechanism either receives a selection of the geographical region (step 1112) or receives a selection of a category (step 1114). If a selection of a geographical region is received, the enabling mechanism enables the displaying of an advertisement associated with the selected geographical region (step 1116). A determining mechanism then determines whether to display an additional advertisement associated with the selected geographical region (step 1120). If an additional advertisement is to be displayed, step 1116 is repeated.

If a selection of a category region is received, the enabling mechanism enables the displaying of an advertisement associated with the selected category (step 1118). A determining mechanism then determines whether to display an additional advertisement associated with the selected category (step 1122). If an additional advertisement is to be displayed, step 1118 is repeated.

If an additional advertisement is not to be displayed, the determining mechanism determines whether another selection of a geographical region or category has been received (step 1124). If another selection of a geographical region or category has been received, either steps 1112, 1116, and 1120 are repeated or steps 1114, 1118, and 1122 are repeated.

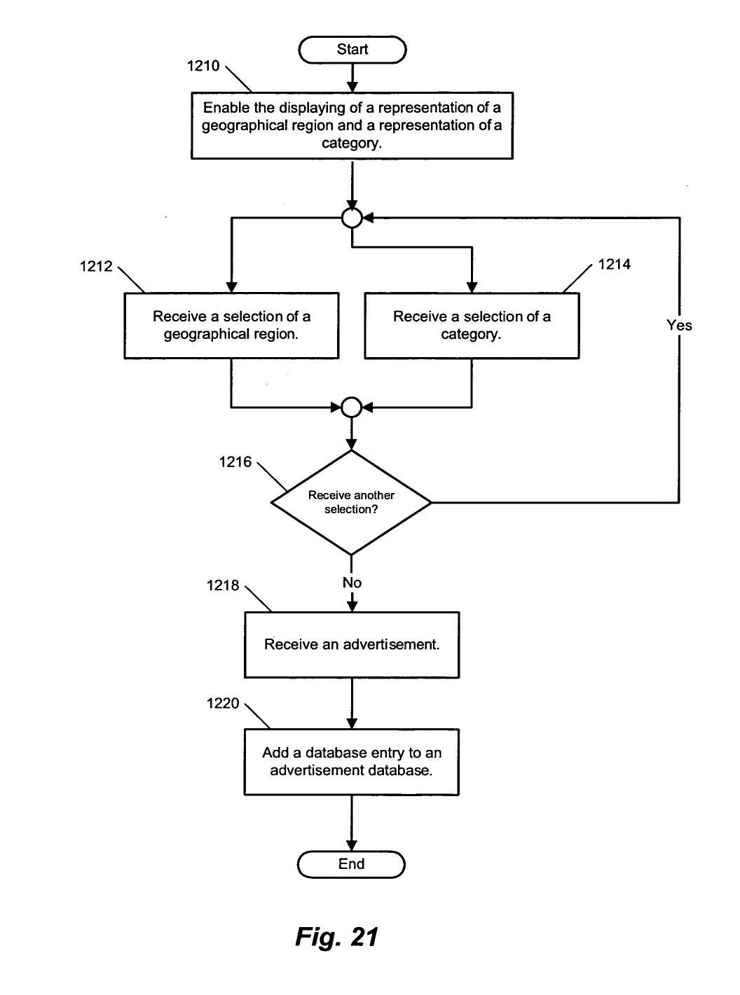

FIG. 21 is a flow diagram illustrating an example of enabling uploading an advertisement according to embodiments of the present disclosure. An enabling mechanism enables the displaying of a representation of a geographical region and a representation of a category (step 1210). A receiving mechanism either receives a selection of a geographical region (step 1212) or a selection of a category (step 1214). Then, a determining mechanism determines whether another selection has been received (step 1216). If another selection has been received, either step 1212 is repeated or step 1214 is repeated. Next, an advertisement is received (step 1218) and a database entry is added to an advertisement database (step 1220).

Marketing

Various marketing strategies may be implemented in conjunction with the advertising database of the present disclosure. These marketing strategies encourage businesses and consumers to access the advertising database and provide exposure for the advertising database company. Among the marketing strategies are a referral program, a petition program, and an auction program.

The referral program rewards users who refer businesses to the advertisement database company. Users receive a credit for each advertisement that a referred business adds to the advertisement database. The petition program allows users to submit business names to the advertisement database company. The petition may then be presented to the business. If the business adds any advertisements to the advertisement database, the petitioning users may receive a credit. In the auction program, the advertisement database company auctions off advertisement space in the advertisement database. For example, the first three advertisement positions associated with a category may be auctioned off, and the three winners of the auction will be guaranteed to show up as one of the first three advertisements when a user chooses that particular category.

Database, Computing, and Network Environments

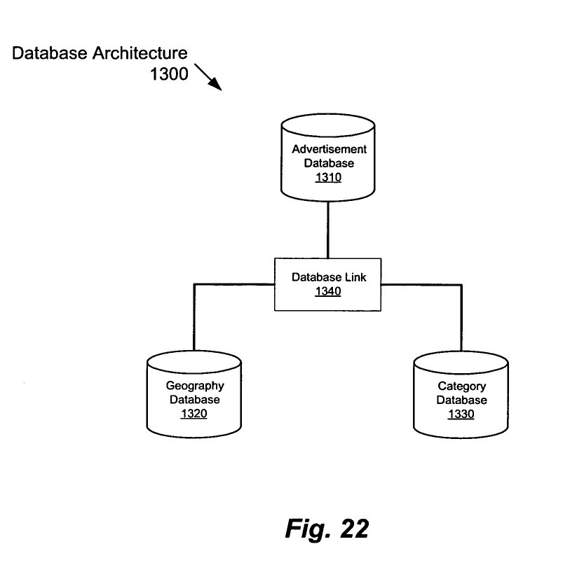

The present disclosure can be implemented using a variety of database architectures, computer systems, and networks. Examples of such database architectures, computer systems and networks are described below with reference to FIGS. 22, 23, and 24.

FIG. 22 depicts a block diagram of a database architecture 1300. Database architecture 1300 includes an advertisement database 1310, a geography database 1320, a category database 1330, and a database link 1340. Geography database 1320 may include a geography hierarchy, such as geography hierarchy 200, and category database 1350 may include a category hierarchy such as category hierarchy 300. FIG. 22 shows that database link 1340 associates advertisement database 1310, geography database 1320, and category database 1330 with one another. Database link 1340 may be any type of mechanism that associates databases or entries within databases with each other. For example, database link 1340 may be an advertisement table, such as advertisement table 600. Database link 1340 may also be an advertisement matrix, such as advertisement matrix 400.

While advertisement database 1310, geography database 1320, and category database 1330 are shown as different storage units, all the databases may be contained within one storage unit, or a single database may span multiple storage units. Furthermore, database link 1340 may be included within advertisement database 1310, geography database 1320, or category database 1330. Alternatively, advertisements within advertisement database 1310 may be directly associated with entries in geography database 1320 and category database 1330. For example, an advertisement may be tagged with data that associates the advertisement with a geographical region and a category.

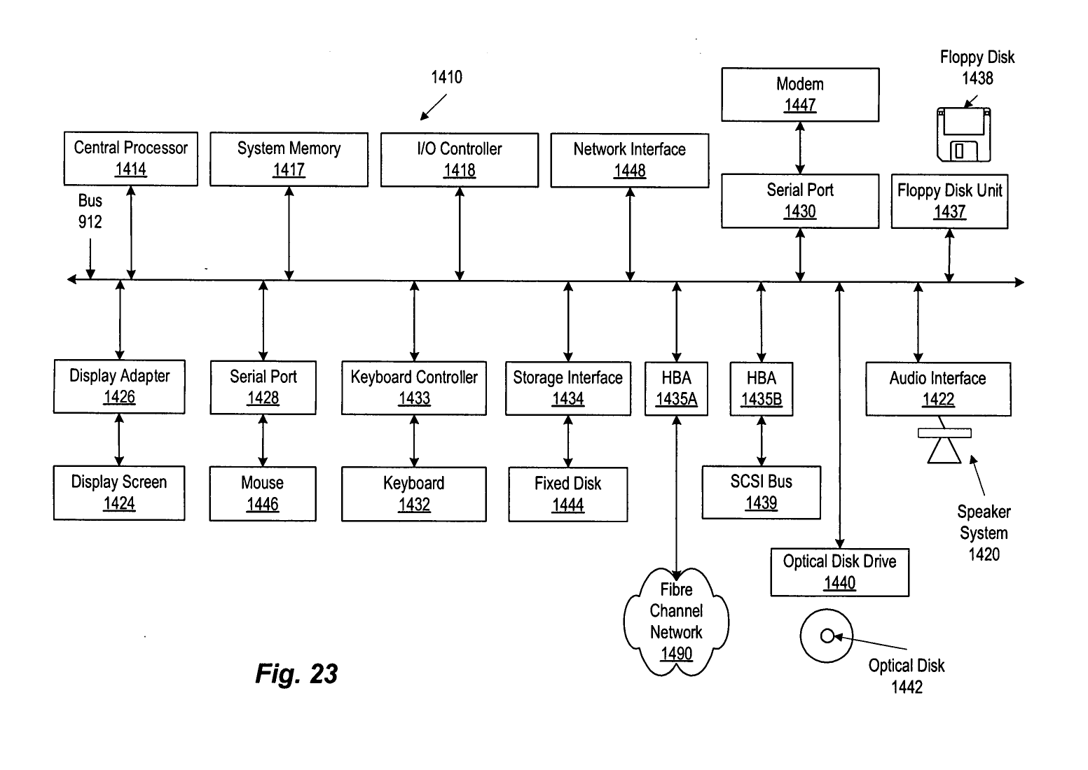

FIG. 23 depicts a block diagram of a computer system 1410 suitable for implementing the databases and other systems presented in the present disclosure. Computer system 1410 includes a bus 1412 which interconnects major subsystems of computer system 1410, such as a central processor 1414, a system memory 1417 (typically RAM, but which may also include ROM, flash RAM, or the like), an input/output controller 1418, an external audio device, such as a speaker system 1420 via an audio output interface 1422, an external device, such as a display screen 1424 via display adapter 1426, serial ports 1428 and 1430, a keyboard 1432 (interfaced with a keyboard controller 1433), a storage interface 1434, a floppy disk drive 1437 operative to receive a floppy disk 1438, a host bus adapter (HBA) interface card 1435A operative to connect with a fiber channel network 1490, a host bus adapter (HBA) interface card 1435B operative to connect to a SCSI bus 1439, and an optical disk drive 1440 operative to receive an optical disk 1442. Also included are a mouse 1446 (or other point-and-click device, coupled to bus 1412 via serial port 1428), a modem 1447 (coupled to bus 1412 via serial port 1430), and a network interface 1448 (coupled directly to bus 1412).

Bus 1412 allows data communication between central processor 1414 and system memory 1417, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 1410 are generally stored on and accessed via a computer readable medium, such as a hard disk drive (e.g., fixed disk 1444), an optical drive (e.g., optical drive 1440), a floppy disk unit 1437, or other storage medium. Additionally, applications can be in the form of electronic signals modulated in accordance with the application and data communication technology when accessed via network modem 1447 or interface 1448.

Storage interface 1434, as with the other storage interfaces of computer system 1410, can connect to a standard computer readable medium for storage and/or retrieval of information, such as a fixed disk drive 1444. Fixed disk drive 1444 may be a part of computer system 1410 or may be separate and accessed through other interface systems. Modem 1447 may provide a direct connection to a remote server via a telephone link or to the Internet via an internet service provider (ISP). Network interface 1448 may provide a direct connection to a remote server via a direct network link to the Internet via a POP (point of presence). Network interface 1448 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, all of the devices shown in FIG. 23 need not be present to practice the present invention. The devices and subsystems can be interconnected in different ways from that shown in FIG. 23. The operation of a computer system such as that shown in FIG. 23 is readily known in the art and is not discussed in detail in this application. Code to implement the present invention can be stored in computer-readable storage media such as one or more of system memory 1417, fixed disk 1444, optical disk 1442, or floppy disk 1438. Additionally, computer system 1410 can be any kind of computing device, and so includes personal data assistants (PDAs), network appliance, X-window terminal or other such computing devices. The operating system provided on computer system 1410 may be MS-DOS®, MS-WINDOWS®, OS/2®, UNIX®, Linux®, or another known operating system. Computer system 1410 also supports a number of Internet access tools, including, for example, an HTTP-compliant web browser having a JavaScript interpreter, such as Netscape Navigator®, Microsoft Internet Explorer®, and the like.

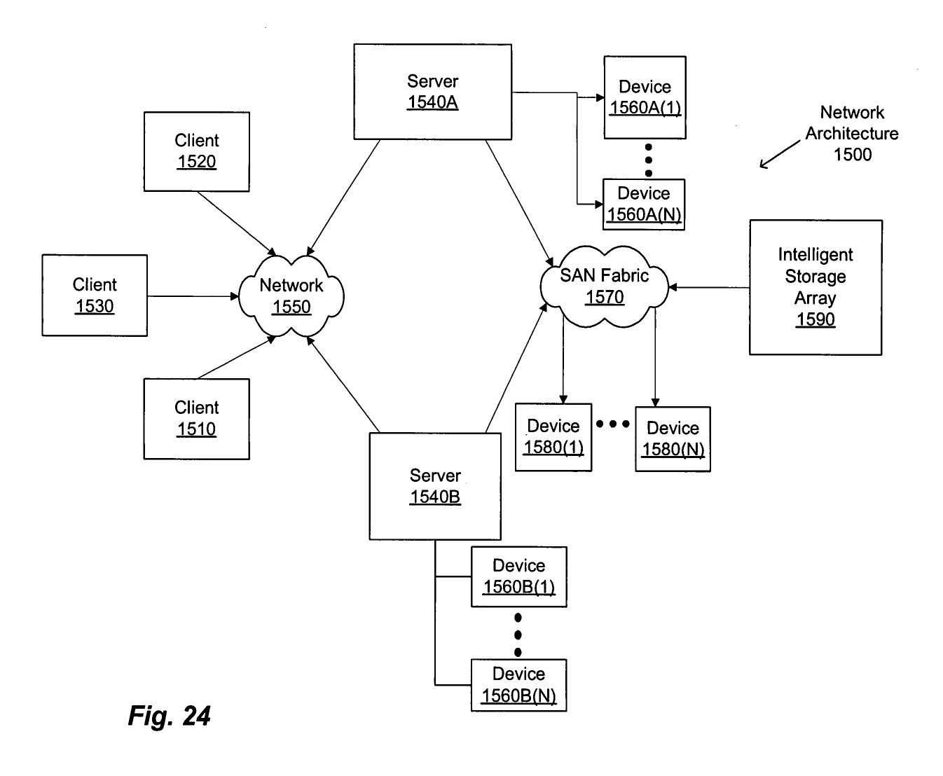

FIG. 24 is a block diagram depicting an example of a network architecture 1500 in which client systems 1510, 1520 and 1530, as well as storage servers 1540A and 1540B (any of which can be implemented using computer system 1410), are coupled to a network 1550. Storage server 1540A is further depicted as having storage devices 1560A(1)-(N) directly attached, and storage server 1540B is depicted with storage devices 1560B(1)-(N) directly attached. Storage servers 1540A and 1540B are also connected to a SAN fabric 1570, although connection to a storage area network is not required for operation of the invention. SAN fabric 1570 supports access to storage devices 1580(1)-(N) by storage servers 1540A and 1540B, and so on by client systems 1510, 1520 and 1530 via network 1550. Intelligent storage array 1590 is also shown as an example of a specific storage device accessible via SAN fabric 1570.

With reference to computer system 1410, modem 1447, network interface 1448 or some other method can be used to provide connectivity from each of client computer systems 1510, 1520 and 1530 to network 1550. Client systems 1510, 1520 and 1530 are able to access information on storage server 1540A or 1540B using, for example, a web browser or other client software (not shown). Such a client allows client systems 1510, 1520 and 1530 to access data hosted by storage server 1540A or 1540B or one of storage devices 1560A(1)-(N), 1560B(1) (N), 1580(1)-(N) or intelligent storage array 1590. FIG. 24 depicts the use of a network such as the Internet for exchanging data, but the present invention is not limited to the Internet or any particular network-based environment.

### OTHER EMBODIMENTS

The present disclosure is well adapted to attain the advantages mentioned as well as others inherent therein. While the present disclosure has been depicted, described, and is defined by reference to particular embodiments of the disclosure, such references do not imply a limitation on the disclosure, and no such limitation is to be inferred. The embodiments recited in this disclosure are capable of considerable modification, alteration, and equivalents in form and function, as will occur to those ordinarily skilled in the pertinent arts. The depicted and described embodiments are examples only, and are not exhaustive of the scope of the invention.

The foregoing describes embodiments including components contained within other components (e.g., the various elements shown as components of computer system 1410). Such architectures are merely examples, and, in fact, many other architectures can be implemented which achieve the same functionality. In an abstract but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

The foregoing detailed description has set forth various embodiments of the present invention via the use of block diagrams, flowcharts, and examples. It will be understood by those within the art that each block diagram component, flowchart step, operation and/or component illustrated by the use of examples can be implemented, individually and/or collectively, by a wide range of hardware, software, firmware, or any combination thereof.

The present invention has been described in the context of fully functional computer systems; however, those skilled in the art will appreciate that the present invention is capable of being distributed as a program product in a variety of forms, and that the present invention applies equally regardless of the particular type of signal bearing media used to actually carry out the distribution. Examples of signal bearing media include recordable media such as floppy disks and CD-ROM, transmission type media such as digital and analog communications links, as well as media storage and distribution systems developed in the future.

The above-discussed embodiments can be implemented by software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention can also include a semiconductor-based memory, which may be permanently, irremovably or remotely coupled to a microprocessor/memory system. Thus, the modules can be stored within a computer system memory to configure the computer system to perform the functions of the module. Various other types of computer-readable storage media may be used to store the modules discussed in the present disclosure.

The above description is intended to be illustrative and should not be taken to be limiting. Other embodiments within the scope of the present invention are possible. Those skilled in the art will readily implement the steps necessary to provide the structures and the methods disclosed herein, and will understand that the process parameters and sequence of steps are given by way of example only and can be varied to achieve the desired structure as well as modifications that are within the scope of the invention. Variations and modifications of the embodiments disclosed herein can be made based on the description set forth herein, without departing from the scope of the invention.

What is claimed is:

1. A method for enabling a display device to display advertisements, the method comprising:
enabling the display device to simultaneously display a first advertisement and a representation of a geographical sub-region, wherein
the geographical sub-region is within a geographical super-region,
the geographical super-region is associated with a first entry in a database, and
the first advertisement is associated with the first entry in the database;
receiving a selection of the geographical sub-region; and
enabling the display device to display a second advertisement, wherein
the geographical sub-region is associated with a second entry in the database, and
the second advertisement is associated with the second entry in the database.

2. The method of claim 1, wherein
the first and second advertisements are associated with a category.

3. The method of claim 2, further comprising:
enabling the display device to display a representation of the category, wherein the category is associated with a third advertisement, and
the third advertisement is associated with the second entry in the database;
receiving a selection of the category; and
enabling the display device to simultaneously display the third advertisement and the representation of the sub-category.

4. The method of claim 1, wherein
the first entry in the database comprises the representation of the geographical super-region, and
the second entry in the database comprises the representation of the geographical sub-region.

5. The method of claim 1, further comprising:
displaying the first advertisement and the representation of the geographical sub-region in a web browser, and
removing the first advertisement from the web browser before displaying the second advertisement.

6. The method of claim 1, wherein
a plurality of geographical super-regions includes the geographical super-region,
a first level of a geographical hierarchy includes the plurality of geographical super-regions,
a plurality of geographical sub-regions includes the geographical sub-region,
each sub-region in the plurality of geographical sub-regions is within the geographical super-region, and
a second level of a geographical hierarchy includes the plurality of geographical sub-regions.

7. The method of claim 6, wherein
the representation of the geographical sub-region comprises at least one of:
a geographical map; and
a textual description of the geographical sub-region;

8. The method of claim 7, wherein the textual description of the geographical sub-region comprises at least one of:
a zip code;
a name of a neighborhood;
a name of a city;
a name of a county;
a name of a state;
a name of a metropolitan area; and
a name of a country.

9. The method of claim 1, further comprising:
enabling the display device to simultaneously display the representation of the geographical sub-region, the first advertisement, a representation of a first category, and a coupon, wherein
the coupon is associated with the first advertisement.

10. The method of claim 9, further comprising:
generating a statistical report, wherein
the statistical report provides data indicating at least one of:
a number of times the coupon has been printed,
a number of times the first advertisement has been viewed, and
a number of times the first advertisement has been bookmarked.

11. The method of claim 1, further comprising:
receiving a selection of a third advertisement; and
enabling the display device to display the third advertisement, wherein
the third advertisement is associated with the second entry in the database.

12. The method of claim 1, wherein
the first entry in the database includes:
a first field identifying the first advertisement, and
a second field identifying the geographical super-region.

13. The method of claim 12, wherein
the first entry in the database further includes:
a third field identifying a category.

14. A method for displaying advertisements, the method comprising:
simultaneously displaying a first advertisement and a map, wherein
the map represents a geographical sub-region,
the geographical sub-region is within a geographical super-region,
the first advertisement is associated with the geographical super-region;
receiving a selection of the geographical sub-region; and
displaying a second advertisement, wherein
the second advertisement is associated with the geographical sub-region.

15. The method of claim 14, wherein
the first and second advertisements are associated with a category.

16. The method of claim 15, further comprising:
displaying a representation of the category, wherein the category is associated with a third advertisement, and
the third advertisement is associated with the geographical sub-region;
receiving a selection of the category; and
simultaneously displaying the third advertisement and a representation of a sub-category.

17. The method of claim 14, wherein
the receiving a selection of the geographical sub-region comprises receiving a selection of the map.

18. The method of claim 14, further comprising:
simultaneously displaying the representation of the geographical sub-region, the first advertisement, a representation of a first category, and a coupon, wherein
the coupon is associated with the first advertisement.

19. The method of claim 1, further comprising:
receiving a selection of a third advertisement; and
displaying the third advertisement, wherein
the third advertisement is associated with the geographical sub-region.

20. A method for enabling a display device to display advertisements, the method comprising:
enabling the display device to simultaneously display a first advertisement and a representation of a geographical super-region, wherein
a geographical sub-region is within the geographical super-region,
the geographical sub-region is associated with a first entry in a database, and
the first advertisement is associated with the first entry in the database;
receiving a selection of the geographical super-region; and
enabling the display device to display a second advertisement, wherein
the geographical super-region is associated with a second entry in the database, and
the second advertisement is associated with the second entry in the database.

21. The method of claim 20, wherein
a plurality of geographical super-regions includes the geographical super-region,
a first level of a geographical hierarchy includes the plurality of geographical super-regions,
a plurality of geographical sub-regions includes the geographical sub-region,
each sub-region in the plurality of geographical sub-regions is within the geographical super-region, and
a second level of a geographical hierarchy includes the plurality of geographical sub-regions.

22. The method of claim 20, wherein
the representation of the geographical super-region comprises at least one of:
a geographical map, and
a textual description of the geographical sub-region.

23. The method of claim 20, wherein
the first entry in the database includes:
a first field identifying the first advertisement, and
a second field identifying the geographical sub-region.

24. A computer program product comprising:
a first set of instructions, executable on a computer system, configured to enable a display device to simultaneously display a first advertisement and a representation of a geographical sub-region, wherein
the geographical sub-region is within a geographical super-region,
the geographical super-region is associated with a first entry in a database, and
the first advertisement is associated with the first entry in the database;
a second set of instructions, executable on the computer system, configured to receive a selection of the geographical sub-region;
a third set of instructions, executable on the computer system, configured to enable the display device to display a second advertisement, wherein
the geographical sub-region is associated with a second entry in the database, and
the second advertisement is associated with the second entry in the database; and
computer readable media, wherein
the computer program product is encoded in the computer readable media.

25. The computer program product of claim 24, wherein
the first and second advertisements are associated with a category.

26. The computer program product of claim 25, further comprising:
a fourth set of instructions, executable on the computer system, configured to enable the display device to display a representation of the category, wherein the category is associated with a third advertisement, and
the third advertisement is associated with the second entry in the database;
a fifth set of instructions, executable on the computer system, configured to receive a selection of the category; and
a sixth set of instructions, executable on the computer system, configured to enable the display device to simultaneously display the third advertisement and a representation of a sub-category.

27. The computer program product of claim 24, wherein
the first entry in the database comprises the representation of the geographical super-region, and
the second entry in the database comprises the representation of the geographical sub-region.

28. The computer program product of claim 24, further comprising:
a fourth set of instructions, executable on the computer system, configured to display the first advertisement and the representation of the geographical sub-region in a web browser; and
a fifth set of instructions, executable on the computer system, configured to remove the first advertisement from the web browser before displaying the second advertisement.

29. The computer program product of claim 24, wherein
the representation of the geographical sub-region comprises at least one of:
a geographical map; and
a textual description of the geographical sub-region.

30. The computer program product of claim 24, further comprising:
a fourth set of instructions, executable on the computer system, configured to enable the display device to simultaneously display the representation of the geographical sub-region, the first advertisement, a representation of a first category, and a coupon, wherein
the coupon is associated with the first advertisement.

31. The computer program product of claim 24, further comprising:
a fourth set of instructions, executable on the computer system, configured to receive a selection of a third advertisement; and
a fifth set of instructions, executable on the computer system, configured to enable the display device to display the third advertisement, wherein
the third advertisement is associated with the second entry in the database.

32. The computer program product of claim 24, wherein
the first entry in the database includes:
a first field identifying the first advertisement, and
a second field identifying the geographical super-region.

33. A computer data signal embodied in a carrier wave, comprising computer instructions for causing a display device to display an advertisement, the computer data signal causing the display device to:
simultaneously display a first advertisement and a map, wherein
the map represents a geographical sub-region,
the geographical sub-region is within a geographical super-region,
the first advertisement is associated with the geographical super-region;
receive a selection of the map; and
display a second advertisement, wherein
the second advertisement is associated with the geographical sub-region.

34. An apparatus comprising:
means for enabling a display device to simultaneously display a first advertisement and a representation of a geographical sub-region, wherein
the geographical sub-region is within a geographical super-region,
the geographical super-region is associated with a first entry in a database, and
the first advertisement is associated with the first entry in the database;
receiving a selection of the geographical sub-region; and
enabling the display device to display a second advertisement, wherein
the geographical sub-region is associated with a second entry in the database, and
the second advertisement is associated with the second entry in the database.

35. The apparatus of claim 34, wherein
the first and second advertisements are associated with a category.

36. The apparatus of claim 35, further comprising:
means for enabling the display device to display a representation of the category,
wherein the category is associated with a third advertisement, and
the third advertisement is associated with the second entry in the database;
means for receiving a selection of the category; and
means for enabling the display device to simultaneously display the third advertisement and a representation of a sub-category.

37. The apparatus of claim 34, wherein
the first entry in the database comprises a representation of the geographical super-region, and
the second entry in the database comprises the representation of the geographical sub-region.

38. The apparatus of claim 34, further comprising:
means for displaying the first advertisement and the representation of the geographical sub-region in a web browser, and
means for removing the first advertisement from the web browser before displaying the second advertisement.

39. The apparatus of claim 34, wherein
a plurality of geographical super-regions includes the geographical super-region,
a first level of a geographical hierarchy includes the plurality of geographical super-regions,
a plurality of geographical sub-regions includes the geographical sub-region,
each sub-region in the plurality of geographical sub-regions is within the geographical super-region, and
a second level of the geographical hierarchy includes the plurality of geographical sub-regions.

40. The apparatus of claim 34, further comprising:
means for receiving a selection of a third advertisement; and
means for enabling the display device to display the third advertisement, wherein the third advertisement is associated with the second entry in the database.

41. The apparatus of claim 34, wherein
the first entry in the database includes:
a first field identifying the first advertisement,
a second field identifying the geographical super-region, and
a third field identifying a category.

42. A system for enabling the displaying of advertisements, the system comprising:
a geography database, wherein
the geography database includes:
a first geographical entry associated with a geographical super-region,
a second geographical entry associated with a geographical sub-region, and
the geographical sub-region is within the geographical super-region;
an advertisement database, wherein
the advertisement database includes:
a first advertisement associated with the first geographical entry, and
a second advertisement associated with the second geographical entry; and
a first module configured to enable simultaneous displaying of a representation of the geographical sub-region and the first advertisement.

43. The system of claim 42, further comprising
a category database, wherein the category database includes
first and second categories, wherein
the second category is a sub-category of the first category, and
the second category is associated with the first advertisement.

44. The system of claim 43, further comprising:
a second module configured to receive a selection of the second category, and
a third module configured to receive a selection of the geographical sub-region

45. The system of claim 42, wherein the geography database further comprises:
a first hierarchical level, wherein
the first hierarchical level includes a plurality of geographical super-regions, and
the plurality of geographical super-regions includes the geographical super-region; and
a second hierarchical level, wherein
the second hierarchical level includes a plurality of geographical sub-regions,
the plurality of geographical sub-regions includes the geographical sub-region, and
each geographical sub-region in the plurality of geographical sub-regions is within the geographical super-region.

46. The system of claim 42, further comprising:
a second module, wherein the second module is configured to receive a selection of the geographical sub-region, and
a third module, wherein the third module is configured to receive a selection of a category.

47. A method for adding advertisements to a database, the method comprising:
enabling a display device to display a representation of a first geographical region;
receiving a selection of the first geographical region;
enabling the display device to display a representation of a second geographical region, wherein the second geographical region is within the first geographical region;
receiving an advertisement; and
adding a database entry to the database, wherein
the database entry associates the first geographical region with the advertisement.

48. The method of claim 47, further comprising:
enabling the display device to display a representation of a category;
receiving a selection of the category; and
associating the advertisement with the category.

49. The method of claim 48, further comprising:
enabling the display device to simultaneously display the representation of the category, the representation of the first geographical region, and the advertisement.

50. The method of claim 47, further comprising:
receiving keywords; and
associating the keywords with the advertisement.

51. The method of claim 47, further comprising:
receiving a coupon; and
associating the coupon with the advertisement.

52. The method of claim 47, wherein
the database entry includes:
a first field identifying the advertisement, and
a second field identifying the first geographical region.

53. The method of claim 47, further comprising:
receiving a coupon, wherein
the database entry associates the advertisement with the coupon.
